(19) United States
(12) Patent Application Publication
(10) Pub. No.: US 2019/0277487 A1
(43) Pub. Date: Sep. 12, 2019

(54) LED BULB WITH GLASS ENVELOPE

(71) Applicant: GE Lighting Solutions, LLC, East Cleveland, OH (US)

(72) Inventors: Xiaojun Ren, ShangHai (CN); Zhifeng Bao, ShangHai (CN); Kun Xiao, ShangHai (CN); Zhiyong Wang, ShangHai (CN); Raghu Ramaiah, Mentor, OH (US); Glenn Howard Kuenzler, Beachwood, OH (US)

(73) Assignee: GE Lighting Solutions, LLC, East Cleveland, OH (US)

(21) Appl. No.: 16/349,591

(22) PCT Filed: Nov. 14, 2016
(86) PCT No.: PCT/CN2016/105677

§ 371 Date: May 13, 2019

(51) Int. Cl. F21V 29/65; F21K 9/238; F21V 29/75; F21K 9/232

(52) U.S. Cl. CPC F21V 29/65; F21K 9/232; F21V 29/75; F21K 9/238

(57) ABSTRACT

Aspects of the present disclosure provide an LED lamp assembly, comprising a glass envelope, an LED platform comprising a printed circuit board supported by a stem assembly disposed within the envelope, a base hermetically sealed to the envelope, and a gas disposed within the envelope. The gas is capable of providing both thermal conductivity between the LED platform and the envelope, while also mitigating volatile organic compounds present within the envelope.

### BACKGROUND

Traditional incandescent and halogen light bulbs create light by conducting electricity through a resistive filament, and heating the filament to a very high temperature so as to produce visible light. The incandescent lamps typically include a transparent glass enclosure with a tungsten filament inside, a glass stem with lead wires, and a medium base for electrical connection. The halogen lamps also typically include a glass enclosure, a glass stem, a medium base and a capsule light engine with one or more filaments and halogen vapor inside. Nowadays incandescent and halogen lamps are being replaced by LED lamps, mainly because LED lamps are much more efficient and save energy, and usually have a much longer service life.

At present, LED lamps with plastic envelopes are available in the market which include a light engine having LED light sources mounted on a metal core printed circuit board, a heat sink thermally coupled with the light engine, a driver inside the heat sink, a base, and a translucent and diffusive envelope. Electrical AC mains power is connected to the base, and the driver converts the AC mains power to direct current to drive the LEDs at a given power and to generate visible light. The light passes through the diffusive plastic envelope to provide a diffuse illumination. During operation, the LED's generate visible light as well as thermal energy. Some of the thermal energy is removed from the LED's by the heat sink. The thermal energy in the heat sink is dissipated somewhat by radiation and convection. Without the heat sink, the LED temperature may rise to a point where its service life is shortened, and may even be damaged.

Compared with LED lamps with plastic envelopes, traditional incandescent and halogen lamps still have several merits. They typically have an omnidirectional light distribution (e.g., almost 4π C radians) which is suitable for most applications. The material cost of the incandescent and halogen lamps is much cheaper, compared to the LED lamps described above. Also they are simple in structure and the manufacturing of these lamps is highly automated, further reducing the cost of these lamps to the consumer.

Recently, filament style LED lamps have been produced that attempt to leverage the merits of the incandescent and halogen lamps. Filament style LED lamps typically include glass envelopes, LED filament packages, and gas inside the envelopes to dissipate heat. A plurality of LED dies are placed in a transparent strip substrate and coated with a mixture of phosphor and silicone to form the LED filament. The heat from the LEDs is dissipated via the gas inside the glass envelope. These style lamps generally achieve a nearly omnidirectional light distribution, are lightweight and have a simple structure. However, the typical filament LED lamp is usually higher in cost because it uses a large number of costly LED dies.

Low cost, good color rendition and high efficiency are factors presently driving the LED lamp market for general lighting. The ability to provide a similar amount of lumens in a package similar to those presently in use would be advantageous. Providing a lamp with a similar color temperature, shape, dimming ability, and light distribution, while using less power and emitting less heat would also be advantageous.

### SUMMARY

Due to the aforementioned problems of the traditional LED lamps with plastic envelopes, and the LED filament lamps, the disclosed embodiments provide a LED lamp that is light weight, has a simple structure, and lower cost. This then overcomes the issues mentioned with the plastic envelope LED lamps, and the LED filament lamps.

In one or more embodiments, an LED lamp includes a translucent envelope or bulb, a light engine (i.e. one or more LED light sources), and a stem to mechanically support and provide electrical power to the light engine. The inside of the bulb is charged with a gas fill that surrounds the light engine to dissipate the heat and avoid lumen degradation caused by the presence of any Volatile Organic compounds (VOCs). Since the bulb is hermetically sealed, the VOCs will continually be evolved, and their presence may degrade the LED light output over time. A component inside the gas fill mitigates the content of, (and therefore, the potential damage from), these VOCs. The light engine of the disclosed embodiments may be implemented as an LED platform, which includes one or more LED light sources placed on a printed circuit board, which can be of the metal core variety (referred to as an MCPCB), and may be a unitary structure. The PCB or MCPCB can be bent or formed into various shapes, such as a polyhedron shape, and may have a coating on the surface to prevent and minimize VOCs that may be released from the printed circuit board. This coating can be a conformal coating, such as a silicone conformal coating, for example, a commercially-available Dow Corning conformal coating, the types of which would be understood by those skilled in the art. The glass stem structure can extend through the polyhedron, and provide additional mechanical support to the PCB board. A set of lead wires (e.g., a pair of lead wires) may extend from the glass stem to the printed circuit board and may be used to provide electrical power to the PCB board and also provide mechanical support. The other end of the lead wires may be connected to the mains supply through the base. In some embodiments, a power supply may be located below the PCB or MCPCB and the other end of the lead wires may extend to the power supply which in turn may be connected to the mains supply through the base (wherein “below” is in the context of the lamp being in an upright position with base down).

At least one embodiment, an LED lamp includes a glass envelope (or “bulb”), a gas filling the inside of the bulb which includes at least helium, an LED platform including LEDs placed on a polygonal PCB board, a stem section that goes through the polygon and touches the top of the PCB board, and a set of wires extending through at least a portion of the stem and connected to the PCB physically and electrically. The glass bulb is sealed with the stem. A base is attached to the bulb with a base adhesive. In some embodiments, a driver may be located inside the base to convert AC power to DC in order to the drive the LEDs. In one or more embodiments, the PCB can be coated on at least a portion of a surface thereof with a conformal coating that will minimize VOC transport into the bulb.

One or more embodiments of an LED lamp include a glass bulb, a gas filling the bulb, an LED platform including LEDs which are placed on a PCB board shaped into a polygon, and a stem with metal wires extending from an upper side of a glass column of the stem, wherein the stem extends through an interior of the polygon shaped PCB board and the metal wires mechanically prevent PCB board misalignment during shipping or in use. The wires may also extend from a lower side of the glass column of the stem to provide an electrical connection to the PCB. The glass bulb may be sealed to the stem, forming a hermetic enclosure. A driver may be located inside the base to convert AC power to DC in order to the drive the LEDs. In an alternative embodiment, the driver may not be located inside the base but instead may be located on the PCB to be hermetically sealed within the glass envelope.

Some embodiments of an LED lamp include a glass bulb, a gas fill comprising helium and oxygen sealed within the glass bulb, an LED platform with LEDs placed on a trigeminal-shape or cross-shaped PCB board pillar, and a stem that goes through the center of PCB pillar to support it. Helium gas is including in the fill dissipate the heat from the LED platform to the glass bulb, and the oxygen gas is present in the fill to mitigate the degradation of lumen output of the LEDs from VOC's.

Further embodiments of an LED lamp include a glass bulb, gas inside the bulb, an LED platform with LEDs placed on a polygonal PCB board, and a stem of polygon shape which can touch the PCB board on two or more sides, so as to additionally support the PCB board, and improve the heat conduction and convection.

Some embodiments of an LED lamp may include a circuit board having a bend at the top, forming a steeple like structure. This has a dual advantage of providing a narrow region through which the stem extension can go through, for preventing misalignment of the PCB. In addition, LED's can be placed on the steeple section to provide light which is directed in an upward direction (i.e., away from base), and help with providing a near-4 π light distribution (e.g., omnidirectional).

At least one embodiment is directed to an LED lamp assembly including an envelope, an LED platform comprising a flexible single piece metal core printed circuit board supported by a stem arrangement disposed within the envelope, a base hermetically sealed to the envelope, and a gas disposed within the envelope providing thermal conductivity between the LED platform and the envelope while mitigating volatile organic compounds present within the envelope. Typically, the gas fill may comprise oxygen, which is capable of reacting with VOCs to form carbon oxides or other products.

The metal core printed circuit board may include printed circuit material formed into a shape with multiple sides with LED light sources mounted on exterior surfaces of the multiple sides.

The metal core printed circuit board may include printed circuit material formed into a polyhedron with LED light sources mounted on exterior surfaces of the polyhedron.

The printed circuit material may form a steeple shape on an end of the polyhedron with LED light sources mounted on exterior surfaces of the steeple shape.

The metal core printed circuit board may include printed circuit material formed into a plurality of spokes disposed around a central opening.

The spokes may divide an interior of the envelope into segments, the LED platform comprising LED light sources mounted on surfaces of the LED platform facing into the segments.

The LED lamp assembly may include conductors extending through the stem arrangement connected to pins attached to the LED platform for fixing the LED platform to the stem arrangement.

The LED lamp assembly may include one or more support wires extending through an upper portion of the stem arrangement and contacting the LED platform to reduce vibration of the LED platform.

The LED lamp may include one or more support wires extending through an upper portion of the stem arrangement and contacting the LED platform to maintain alignment of the LED platform.

The LED lamp assembly may include one or more support wires extending through an upper portion of the stem arrangement and contacting the LED platform to center the LED platform within the envelope.

The LED lamp assembly may include a coating disposed on one or more surfaces of the LED platform to minimize a release of volatile organic compounds from the LED platform.

The gas disposed within the envelope may comprise a mixture of helium and oxygen.

The gas disposed within the envelope may include a ratio of helium to oxygen selected to achieve both a predetermined thermal conductivity and a predetermined lumen output over a predetermined time period.

The gas disposed within the envelope may include a ratio (by volume) of 80% helium to 20% oxygen.

The gas disposed within the envelope may include a ratio of 85% helium to 15% oxygen.

The gas disposed within the envelope may include a ratio by volume of from 80% helium/20% oxygen to 85% helium/15% oxygen.

### BRIEF DESCRIPTION OF THE DRAWINGS

The foregoing and other aspects of the disclosed embodiments are made more evident in the following detailed description, when read in conjunction with the attached figures, wherein:

FIG. 1 shows an assembled view of an exemplary LED lamp according to one or more of the disclosed embodiments;

FIG. 2 is an exploded view of the exemplary LED lamp;

FIG. 3 shows an exemplary LED platform fixed to a stem arrangement;

FIG. 4 illustrates an exemplary metal core printed circuit board;

FIG. 5 shows an exemplary embodiment where the stem arrangement protrudes through a steeple structure to provide additional mechanical support;

FIGS. 6A-6F show perspective views of exemplary embodiments of an LED platform where one or more wires attached to an upper portion of the stem arrangement provide additional mechanical support;

FIGS. 7A and 7B show yet another exemplary embodiment of an LED platform;

FIGS. 8A and 8B illustrate still another exemplary embodiment of an LED platform according to the disclosed embodiments, where a rectangular pillar provides additional mechanical support and heat transfer benefits;

FIG. 9A shows a percentage of lumens (% LM) emitted by an exemplary LED using different concentrations of oxygen in a mixture of helium and oxygen; and

FIG. 9B illustrates the impact of oxygen content on He thermal conductivity.

### DETAILED DESCRIPTION

The disclosed embodiments are directed to an LED lamp assembly that provides sufficient lumen output, thermal management, color control, and light distribution characteristics that may be manufactured using existing incandescent production techniques. Thermal management, color control, and sufficient lumen output are among the significant challenges facing most LED lamp designs, in particular applications for retrofitting existing light fixtures with LED light sources. These constraints are clearly evident when evaluating cost effective commercially available retrofit LED lamps. The disclosed embodiments are directed to a method for improving the performance of an LED assembly when it is encapsulated within a low cost glass envelope, and manufactured by high speed machines used for standard incandescent lamps. This existing glass envelope technology is highly desirable because the envelope is easily identified by consumers and is easily supported by current manufacturing components, machinery and techniques. For example, a halogen lamp finishing process that installs a halogen capsule inside a glass envelope may be easily adapted to install the LED platform of the disclosed embodiments. The resulting LED lamp may have a look and feel almost indistinguishable from an existing incandescent lamp, have a longer life, and may be produced at a reasonable cost.

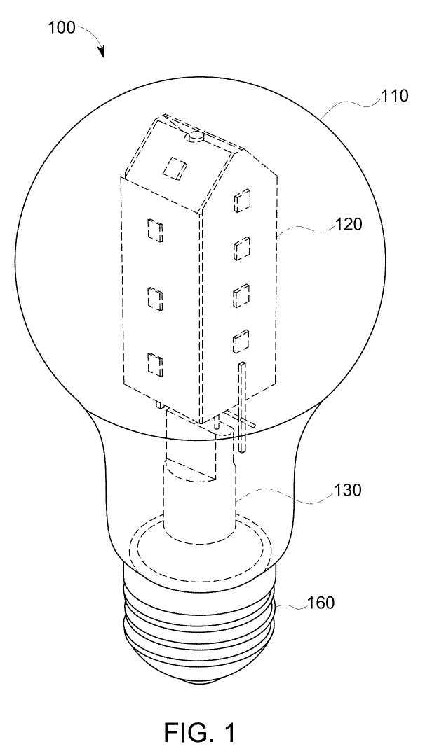

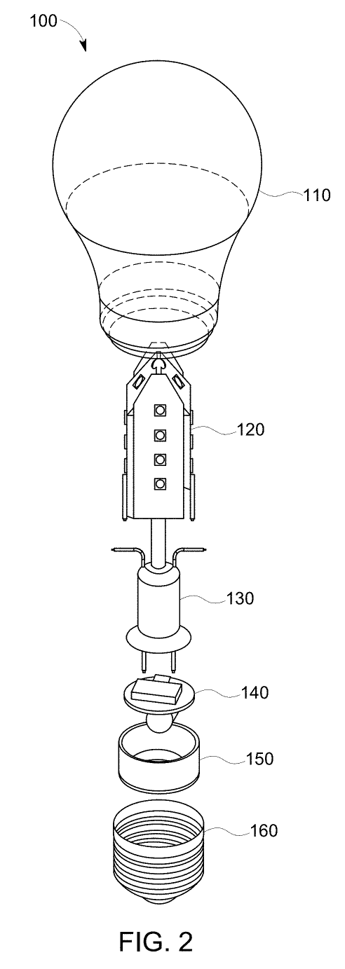

FIG. 1 shows an assembled view of an exemplary LED lamp 100 according to the disclosed embodiments and FIG. 2 shows an exploded view of the LED lamp 100. The LED lamp 100 may include an envelope 110, an LED platform 120, a stem arrangement 130, a power supply 140 (see FIG. 2), an insulator 150 (FIG. 2), and a base 160.

The envelope 110 may generally enclose the LED platform 120 and the stem arrangement 130 and may be constructed of glass, translucent ceramic, or other suitable material for transmitting light while maintaining a gas tight or gas impermeable enclosure. While an “A” type envelope is shown, it should be understood that the disclosed embodiments may include any suitable envelope shape. At least one surface of the envelope 110 may inherently diffuse light or may include at least a partial coating, frosting, texturing, a specular coating, a dichroic coating, embedded light scattering particles, or any other surface characteristic or material for diffusing light. The surface characteristic or material may increase the light output by reducing losses caused by bounce of light. In some embodiments, the surface characteristic or material may operate to minimize or counteract any volatile organic carbon (VOC) release from components within the envelope 110. The envelope 110 may be vacuum sealed to a flange 135 of the stem arrangement and may be filled with a gas as described in detail below.

In the embodiment shown in FIGS. 1 and 2, the power supply 140 is located in the base 160 and insulated by insulator 150. In other embodiments, the power supply 140 may be mounted partly or wholly within the envelope 110. In some embodiments, the power supply 140 may be incorporated as part of the LED platform 120 to facilitate installation of the LED platform 120 into the LED lamp 100 using techniques similar to those for installing a halogen capsule inside an envelope as mentioned above. As used herein, “power supply” may comprise driver circuitry and/or controller circuitry for providing power to LEDs within the envelope 110.

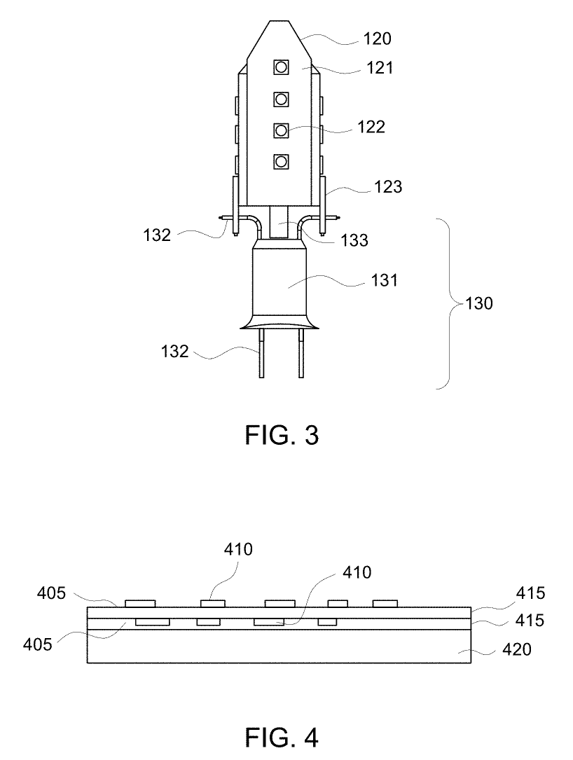

Referring to FIG. 3, in some embodiments, the stem arrangement 130 may include a first support 133 mounted on a second support 131. The first and second supports 133, 131 may be composed of a rigid material, for example, glass or any suitable support material. In some embodiments, one or more of the first and second supports 133, 131 may comprise a heat conducting material, for example, a metal, for conducting heat from the LED platform 120. The first and second supports 133, 131 may each have a cylindrical, rectangular, square, or any suitable shape. One, two, or more of conductors 132 may extend through at least the second support 131 and may be connected to pins 123 on the LED platform 120 to provide support for the LED platform 120. The conductors 132 may also provide a connection to a mains supply through the base 160 of the LED lamp 100. The mains supply may typically range from 120V to 240V A.C. but may include other voltages.

Still referring to FIG. 3, the LED platform 120 may include one or more LEDs 122 mounted on an LED mounting board 121. The LEDs 122 may comprise blue LED chips covered by one or more phosphors, a white light emitting package such as a Nichia 757 package, or any suitable LED components. The LEDs 122 may be surface mount components with a specific color temperature and a light distribution pattern of approximately 120 degrees, however, any suitable color temperature or combination of color temperatures, and any suitable light distribution pattern or combination of light distribution patterns may be used in the disclosed embodiments.

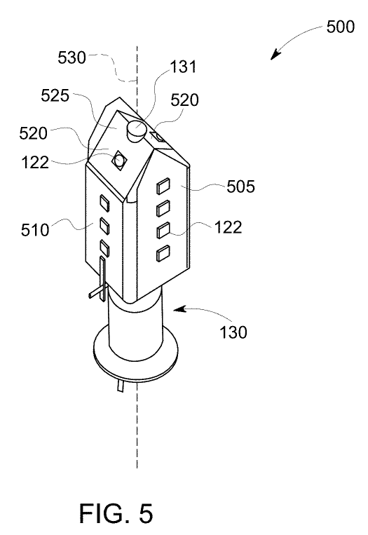

The LED mounting board 121 may be made of a material suitable for mounting the LEDs and other electronic components. As shown in the example of FIG. 4, in some embodiments, the LED mounting board 121 may include one or more circuit layers 405 supporting a number of conductors 410, one or more thermally conductive but electrically insulating dielectric layers 415 and a metal layer 420 that operates as a heat sink, otherwise referred to as a metal core printed circuit board (MCPCB). The metal layer 415 may include aluminum, copper, a mixture of alloys or any suitable metallic material.

While a standard MCPCB may have an exemplary thickness of approximately 2 mm, the LED mounting board 121 of the disclosed embodiments may be flexible and bendable and may have an exemplary thickness of from about 0.1 mm to about 0.8 mm in order to facilitate forming the LED mounting board 121 into various shapes. In some embodiments, the LED mounting board 121 may comprise a single sheet or piece formed into a shape with multiple sides for mounting the LEDs 122. While the LED mounting boards 121, and 505, 605, 705, 805 described below, of the disclosed embodiments are described in terms of polygons and polyhedrons, it should be understood that the LED mounting boards 121, 505, 605, 705, 805 may have any shape suitable for implementing the embodiments disclosed herein including, for example, hexagonal, cross, and herringbone shapes.

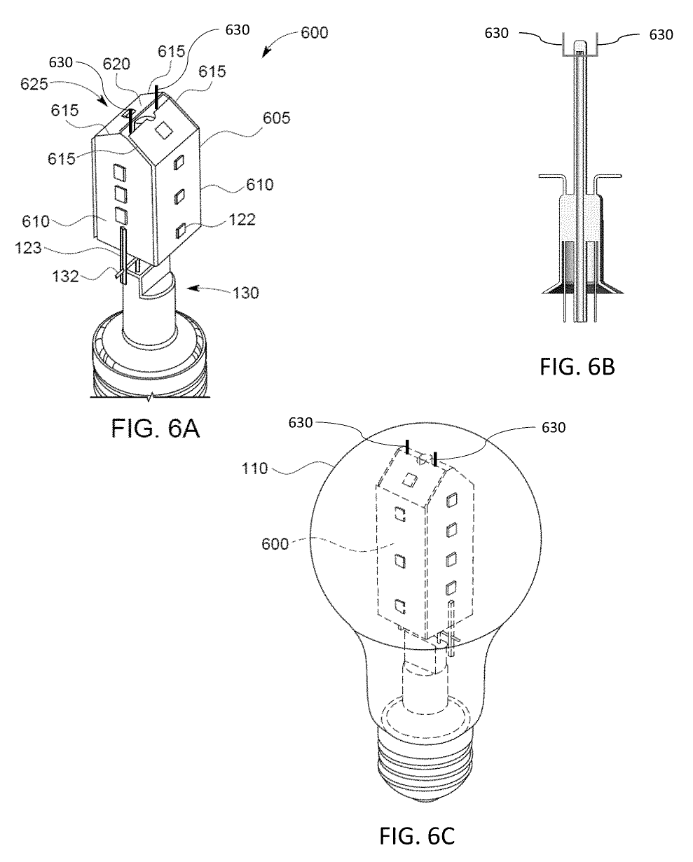

FIG. 5 shows an exemplary embodiment where an LED platform 500 includes an LED mounting board 505 with a plurality of polygons 510 forming a polyhedron including surfaces 520 forming a steeple 525. The LEDs 122 may be mounted on the polygons 510 and the steeple surfaces 520 facing outwards from a center 530 of the LED mounting board 505. The surfaces 520 forming the steeple 525 provide LED mounting surfaces that result in a more uniform light distribution. The steeple 525 may also provide a support point for maintaining the LED mounting board 505 in a position on the first support 133 (see FIG. 3) of the stem arrangement 130.

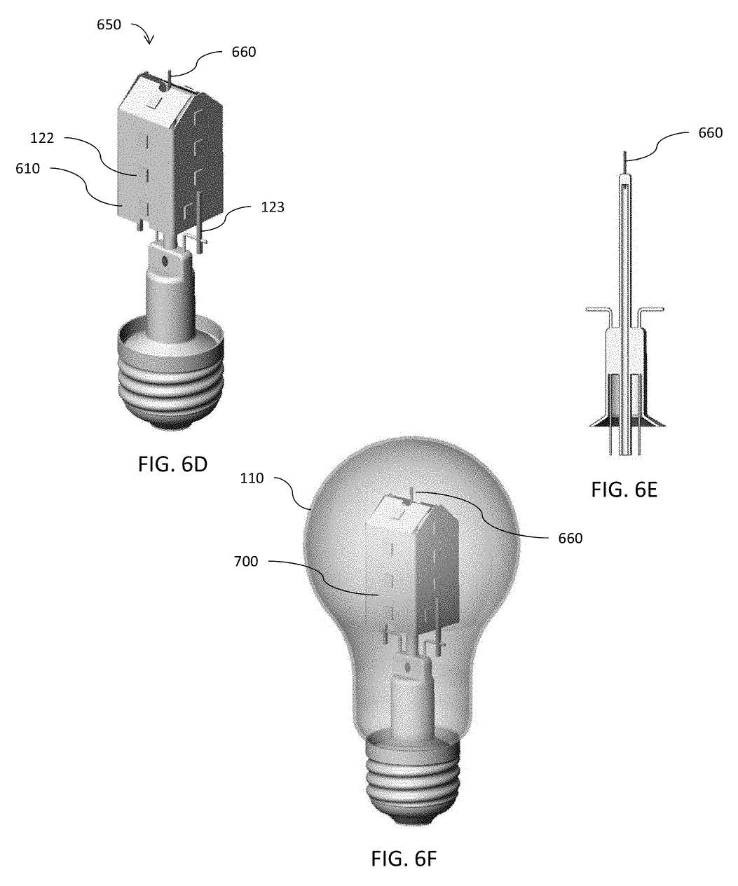

FIGS. 6A-6C show perspective views of another exemplary embodiment of an LED platform 600. In FIG. 6A, an LED mounting board 605 includes various polygonal shaped surfaces 610, 620, where edges 615 of surfaces 620 forming a steeple 625, meet with opposing surfaces 610 of the LED mounting board 605. In this embodiment, a lower portion of the LED platform 600 may be supported by conductors 132 extending from the stem 130 and connected to pins 123 attached to the LED platform 600. LEDs 122 are mounted on each outer facing surface of the LED mounting board 605 to achieve a uniform light distribution. In some embodiments, the first support 133 of the stem arrangement 130 may be hollow and at least two support wires 630 may extend from the first support 133 of the stem arrangement 130 and provide support for the LED platform 600. The support wires 630 may generally contact the LED platform 600 and operate to reduce vibration of the LED platform 600, maintain alignment of the LED platform 600 and center the LED platform within the envelope 110 during lamp assembly, shipping, or while in use. FIG. 6B shows an implementation of the stem arrangement 130 with the support wires 630. The support wires 630 may extend laterally and then vertically from the first stem support 133. The support wires may 630 may be connected to, or may be integral with, a center wire 635 connected to the first stem support 133. The center wire may extend vertically through the first support 133 and may be fastened to an upper portion of the first support 133, for example, by jet firing and melting the upper portion of the first support 133 around the center wire 635. FIG. 6C shows the exemplary LED platform 600 supported by support wires 630 and positioned within the envelope 110.

FIGS. 6D-6F show perspective views of another exemplary embodiment of an LED platform 650. In this embodiment, the first support 133 (FIG. 3) of the stem arrangement 130 may be hollow and a single support wires 660 may extend from the first support 133 of the stem arrangement 130 and provide support for the LED platform 650. Similar to the support wires 630 disclosed above, the support wire 660 may generally operate to reduce vibration of the LED platform 600, maintain alignment of the LED platform 650, and center the LED platform within the envelope 110 during lamp assembly, shipping, or while in use. FIG. 6E shows an implementation of the stem arrangement 130 with the support wires 660. The support wire 660 may extend vertically from the first stem support 133. The support wire 660 may further extend vertically through the first support 133 and may be fastened to an upper portion of the first support 133, for example, by jet firing and melting the upper portion of the first support 133 around the support wire 660. FIG. 6F shows the exemplary LED platform 700 supported by support wire 660 and positioned within the envelope 110.

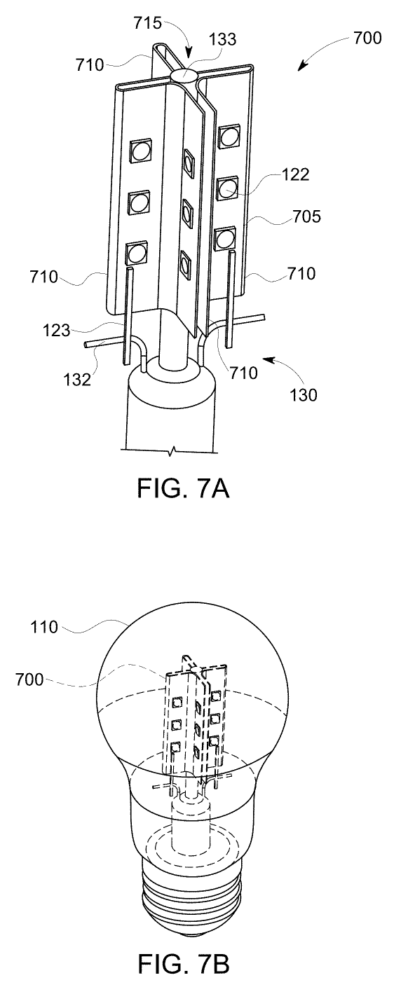

FIGS. 7A and 7B show yet another exemplary embodiment of an LED platform 700 (a perspective view). In this embodiment, the LED platform 700 includes an LED mounting board 705 formed into a plurality of spokes 710 around a central opening 715, and fixed to the first support 133 of the stem arrangement 130, via the central opening 715. Fixing the LED mounting board 705 to the first support 133 ensures that the position of the LED platform 700 will be secured. Further support may be provided by conductors 132 extending from the stem 130 and connected to pins 123 attached to the LED platform 700. It should be understood that, while the LED platform 700 is shown as having four spokes 710, the LED platform 700 may be implemented with any number of spokes 710. When the LED platform 700 is installed in the envelope 110, the spokes 710 of the LED mounting board 705 may divide the interior of the envelope 110 into segments. LEDs 122 are mounted on the surfaces of the LED mounting board 705 facing into the segments to achieve a uniform light distribution. FIG. 7B shows the exemplary LED platform 700 positioned within the envelope 110.

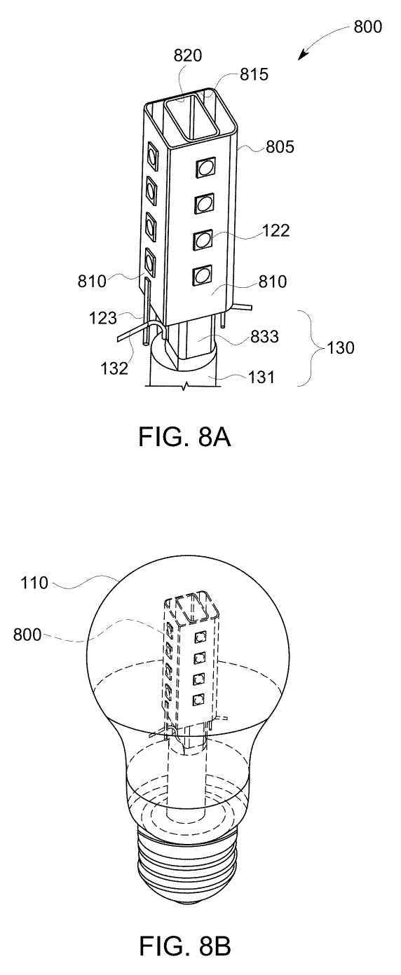

An additional exemplary embodiment is illustrated in FIGS. 8A and 8B. In this embodiment, the LED platform 800 includes an LED mounting board 805 having the shape of a rectangular prism. LEDs 122 may be mounted on outer-facing surfaces 810 of the LED mounting board 805. In this embodiment as well as the other disclosed embodiments, at least the first support 833 of the stem arrangement may also have a rectangular prism shape and the LED mounting board 805 may be fixed to the first support 833. For example, one or more interior surfaces 815 of the LED mounting board 805 may be fastened to one or more exterior surfaces 820 of the first support 833 to enhance the stability of the LED mounting board 805 and maintain the position of the LED platform 800 throughout the life of the LED lamp 100. As mentioned above, the first support 833 may be constructed of a heat conducting material, for example, a metal, to enhance thermal conductive heat transfer from the LED mounting board 805. The first support 833 may further be constructed to include a hollow interior or may be formed as a tube structure to enhance convective heat transfer through the first support 833. Additional support may be provided by conductors 132 extending from the stem 130 and connected to pins 123 attached to the LED platform 800. FIG. 8B shows the exemplary LED platform 800 positioned within the envelope 110.

Each embodiment of the LED mounting board 121, 505, 605, 705, 805 may also be constructed to include a hollow interior or may be formed as a tube structure to enhance convective heat transfer, for example, by way of a chimney effect. In addition, the surface area and shapes of the conductors 410 and metal layer 415 (FIG. 4) of the LED mounting boards may be selected to achieve particular thermal characteristics. By using selected surface areas and shapes, heat may be more efficiently dissipated from the LEDs 122 allowing for the application of additional power to the LEDs 122.

Returning to a discussion of FIG. 1, the envelope 110 may be charged with a gas fill to improve heat flow from the LED platform 120 to the envelope 110. In some embodiments, the use of a low atomic weight heat transfer gas, for example helium, can provide an improved heat transport between the LED platform 120 and the envelope 110 and provide a moisture free environment within the envelope 110. According to the disclosed embodiments, the envelope 110 may be sealed (i.e., hermetically sealed) to retain the heat transfer gas (e.g., a gas comprising helium). The sealed envelope 110 typically has no openings to the outside environment. The conductors 132 (FIG. 3) may extend from the base 160 through the sealed envelope 110 in a fashion that does not allow leakage of the heat transfer gas out of, or allow ambient atmosphere into, the envelope 110.

A typical LED 122 includes an LED chip with a blue LED die coated with a phosphor and covered with a silicone enclosure. VOCs used in LED construction and production processes are known to cause lumen degradation of LEDs operating in a closed environment with little or no gas exchange, for example, the closed environment within the sealed envelope 110. Various components of the LED platform 120, 500, 600, 700, 800 such as the LED mounting board 121, 505, 605, 705, 805, LEDs 122, and solder used in the assembly process may release VOCs during lamp operation. The VOCs may accumulate in the silicone enclosure disposed over the LED die and may discolor, generally causing undesirable lumen loss and dramatic undesirable chromaticity changes.

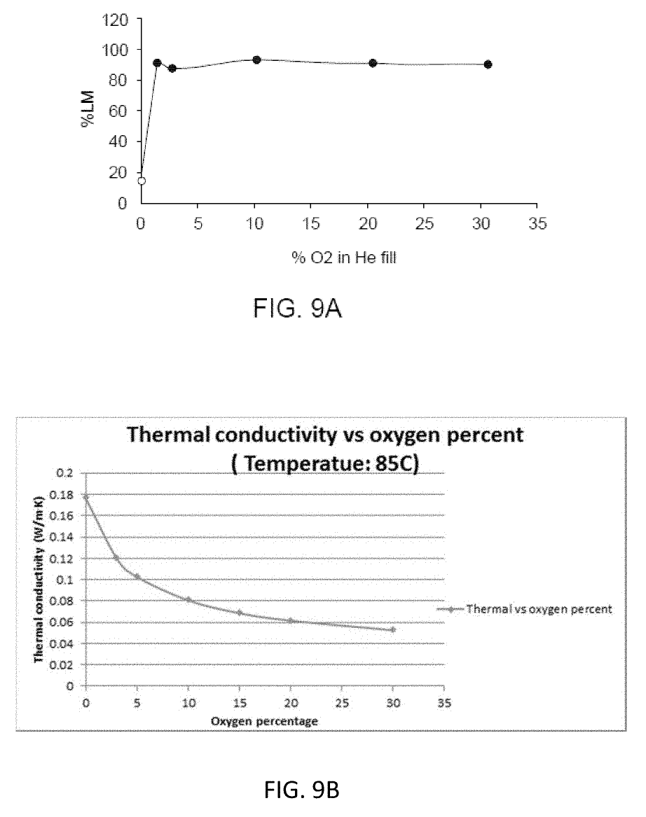

A coating, for example, a silicone conformal coating, may be applied to the LED platform 120, 500, 600, 700, 800 or at least the LED mounting board 121, 505, 605, 705, 805 to at least reduce the amount of VOCs outgassing from the various components within the envelope 110. In addition, oxygen generally reacts with VOCs to avoid the lumen degradation and chromaticity changes. FIG. 9A shows a percentage of lumens (% LM) emitted by an exemplary LED after 2000 hours using different concentrations of oxygen in a mixture of helium and oxygen. As shown in FIG. 9A, a relatively small percentage of oxygen, for example 3% may dramatically reduce lumen degradation compared to using no oxygen. As a result, a mixture of gases including at least helium and oxygen may be used to fill the envelope 110. While helium may have higher thermal conductivity compared to other common gases such as nitrogen, neon, argon, or krypton, the presence of oxygen in the envelope may reduce the thermal dissipating capability of helium. Referring to the example shown in FIG. 9B, even with a 3% volume of oxygen, the thermal conductivity of the mixed gas at 85° C. may decrease from approximately 0.18 W/m−K to approximately 0.12 W/m−K, that is, a decrease in thermal conductivity of around 30%. Thus, a ratio of helium to oxygen should be selected that achieves both an acceptable thermal conductivity and an acceptable lumen output over the life of the LED lamp 100. Referring again to FIG. 9B (in one example embodiment), it can be seen that: if the oxygen content in the fill remains at approximately 15% (resulting in the thermal conductivity of the gas mixture being maintained at or above approximately 0.06 W/m−K), then enough oxygen would be present in the envelope to react with the VOCs such that the life of the LED lamp will not be compromised. For example, using an LED lamp design with a rated output of 800 lumens (often referred to as a 60 W equivalent LED lamp), the oxygen percentage may be above 10%, and the oxygen percentage may be even higher for larger lumen design lamps. In some embodiments, an 80% to 20% ratio of He to O₂ may be used. In one or more embodiments, an 85% to 15% ratio of He to O₂ may be used. In at least one embodiment, the gas disposed within the envelope comprises a ratio of between 80% helium to 20% oxygen and 85% helium to 15% oxygen. While different ratios of helium and oxygen are disclosed, it should be understood that any ratio of helium and oxygen may be utilized provided that a suitable thermal conductivity and lumen output may be maintained over a desired life of the LED lamp. Thus, the gas disposed within the envelope comprises a ratio of helium to oxygen selected that achieves both a predetermined thermal conductivity and a predetermined lumen output over a predetermined time period.

The LED platform may be handled and processed in manufacturing in a manner similar to the halogen bulb assembly process described above.

The disclosed embodiments provide an LED platform having different shapes. Because the internal neck diameter of a typical envelope may be limited, the width of any assembly to be inserted through the neck is also typically limited by the size of the neck diameter. That is, the maximum lateral extent of the LED platform is generally less than the diameter of an opening in a neck of a glass envelope, prior to assembly. The presently disclosed embodiments provide various configurations of the LED platform that meet the size limitations while also providing an increased surface area that affords both an enhanced optical distribution and an enhanced thermal distribution. In particular, the distribution of the LEDs across the increased surface area provides an almost 47c light distribution along with better thermal spreading and transfer of heat to the envelope.

It may be advantageous to include a power supply 140 on-board the LED platform. If such power supply 140 is of a sufficiently small size, then the final lamp assembly can be manufactures by a process similar to the halogen bulb finishing process. For some embodiments, existing production lines for manufacturing of halogen lamps may be adapted, with only slight modifications to the process (i.e. fill-gas changes and flame adjustments). Another advantage is that the connections to the stem conductors is not polarity specific, greatly reducing the possibility of mis-wiring the mains connection to the LED platform.

Using a helium-oxygen filled envelope in one or more embodiments enables efficient and fast transport of the heat away from the LED platform, the LEDs, and the power supply, to the surface of the envelope and thus to the outside environment, while maintaining the lumen output of the LEDs. This approach provides simultaneous cooling to both the LEDs and the power supply. Low atomic mass gas cooling using a selected ratio of helium to oxygen provides operating temperatures within specified bounds of LED operation. Effective heat transport has been demonstrated at fill pressures as low as approximately 50 Torr, however any suitable fill pressure may be utilized.

In accordance with some embodiments, the present disclosure also provides a lamp (or lighting apparatus) comprising the described LED platform contained within a glass envelope enclosing the heat transfer gas (such as helium), wherein the glass envelope is hermetically sealed to contain the LED platform and the heat transfer gas. In accordance with some embodiments, driver circuitry and/or controller circuitry is enclosed within the sealed glass envelope, and there typically may be no driver circuitry or controller circuitry outside the sealed glass envelope.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Various features of the different embodiments described herein are interchangeable, one with the other. The various described features, as well as any known equivalents can be mixed and matched to construct additional embodiments and techniques in accordance with the principles of this disclosure.

Furthermore, some of the features of the exemplary embodiments could be used to advantage without the corresponding use of other features. As such, the foregoing description should be considered as merely illustrative of the principles of the disclosed embodiments and not in limitation thereof.

1. An LED lamp assembly, comprising:
a glass envelope;
an LED platform comprising a printed circuit board supported by a stem assembly disposed within the envelope;
a base hermetically sealed to the envelope; and
a gas disposed within the envelope providing thermal conductivity between the LED platform and the envelope while mitigating volatile organic compounds present within the envelope.

2. The LED lamp assembly of claim 1, wherein the printed circuit board comprises printed circuit material formed into a shape with multiple sides with LED light sources mounted on exterior surfaces of the multiple sides.

3. The LED lamp assembly of claim 1, wherein the printed circuit board comprises printed circuit material formed into a polyhedron with LED light sources mounted on exterior surfaces of the polyhedron.

4. The LED lamp assembly of claim 3, wherein the printed circuit material forms a steeple shape on an end of the polyhedron with LED light sources mounted on exterior surfaces of the steeple shape.

5. The LED lamp assembly of claim 1, wherein the printed circuit board comprises printed circuit material formed into a plurality of spokes disposed around a central opening.

6. The LED lamp assembly of claim 5, wherein the spokes divide an interior of the envelope into segments, the LED platform comprising LED light sources mounted on surfaces of the LED platform facing into the segments.

7. The LED lamp assembly of claim 1, comprising conductors extending through the stem assembly connected to pins attached to the LED platform for fixing the LED platform to the stem assembly.

8. The LED lamp assembly of claim 1, comprising one or more support wires extending through an upper portion of the stem assembly and contacting the LED platform to reduce vibration of the LED platform.

9. The LED lamp assembly of claim 1, comprising one or more support wires extending through an upper portion of the stem assembly and contacting the LED platform to maintain alignment of the LED platform.

10. The LED lamp assembly of claim 1, comprising one or more support wires extending through an upper portion of the stem arrangement and contacting the LED platform to place the LED platform within the envelope at an approximately center position.

11. The LED lamp assembly of claim 1, comprising a coating disposed on one or more surfaces of the LED platform configured to minimize a release of volatile organic compounds from the LED platform.

12. The LED lamp assembly of claim 1, wherein the gas disposed within the envelope comprises helium and oxygen.

13. The LED lamp assembly of claim 1, wherein the gas disposed within the envelope comprises a ratio of helium to oxygen selected that achieves both a predetermined thermal conductivity and a predetermined lumen output over a predetermined time period.

14. The LED lamp assembly of claim 1, wherein the gas disposed within the envelope comprises a volume ratio of between about 80% helium to about 20% oxygen, to about 85% helium to about 15% oxygen.

15. The LED lamp assembly of claim 1, wherein the printed circuit board is flexible.

16. The LED lamp assembly of claim 1, wherein the printed circuit board is a single piece metal core printed circuit board.
